(19) United States
(12) Patent Application Publication
(10) Pub. No.: US 2009/0055482 A1
(43) Pub. Date: Feb. 26, 2009

(54) System and Method to Promote Calendar Event Awareness in Instant Messaging Products

(76) Inventors: Jianjun Zhang, Cary, NC (US); Li Xu, Cary, NC (US)

Correspondence Address: HAMILTON & TERRILE, LLP;IBM RSW, P.O. BOX 203518, AUSTIN, TX, 78720, US

(21) Appl. No.: 11/841,083

(22) Filed: Aug. 20, 2007

(51) Int. Cl. G06F 15/16

(52) U.S. Cl. 709/206

(57) ABSTRACT

A method, system and computer-usable medium for providing a current availability status of a user to receive an instant messaging system (IMS) communication. Electronic calendar information to detect the next scheduled event for the selected IMS recipient. The time remaining before the scheduled event begins is determined. The remaining time and other predetermined information about the scheduled event is used to generate a current availability status of the IMS recipient. The current availability status is provided to the IMS sender prior to initiating an IMS session. The IMS sender and receiver are notified when the time remaining before the start of the event expires.

### BACKGROUND OF THE INVENTION

1. Field of the Invention

Embodiments of the disclosure relate in general to the field of computers and similar technologies, and in particular to software utilized in this field. Still more particularly, it relates to providing a current availability status of a user to receive an instant messaging system (IMS) communication.

2. Description of the Related Art

An instant messaging system (IMS) provides a simple way to exchange real-time, text-based messages between users who are connected to on-line or electronic networking environments such as the Internet, intranets, and extranets. These systems, which have gained popularity due to their simplicity and ease of use, require both sender and recipient to be simultaneously logged-on to exchange messages. Users that are logged-on are typically indicated through a visual cue, such as a different icons or text attributes (e.g., font, color, bold face, etc.).

To send an IMS message, a user generally logs on with an IMS client, selects one or more recipients from an address book of other IMS users that are indicated to be on-line, and then composes and sends their message. However, there are situations where the intended recipient may be logged-on but has limited time to participate in an IMS session due to an upcoming event that was previously scheduled. In many cases the IMS message initiator is neither aware of the impending conflict nor the lead time remaining before the event is scheduled to begin. For example, a message sender may initiate an IMS session only to discover that the recipient is scheduled to attend a mandatory meeting and has insufficient time to respond before the meeting begins. Similarly, the IMS session initiator may be in a different time zone and is unaware that the recipient is ready to go to lunch or leave for the day. While the recipient may have sufficient flexibility in their schedule to respond, the subject of the IMS session may not be critical and does not justify the recipient being unnecessarily inconvenienced. In other cases, the message sender may be unaware of scheduling conflicts that are more subtle. For example, in some cultures it is normal to participate in siesta breaks or mid-day prayers.

Current approaches to addressing these issues include the use of electronic calendars that display the intended recipient's scheduled events. If the IMS session initiator has access to the recipient's electronic calendar then potential scheduling conflicts can be avoided. However, access to the electronic calendar may not always be possible. Even if the access is available, the message sender must first check the availability of the recipient, which offsets the immediacy and convenience of the instant messaging system. When it is possible to access the recipient's schedule, it is not always possible to tell if an impending schedule conflict is mandatory or discretionary. Likewise, it can be difficult to tell if the lead time remaining is limited or variable. In view of the foregoing, it would be advantageous to be able to determine the availability of a recipient to receive an IMS communication without having to check their electronic calendar. It would likewise be advantageous to know in advance the amount of lead time remaining before an impending schedule conflict. However, no such solution exists today.

### BRIEF SUMMARY OF THE INVENTION

The present invention includes, but is not limited to, a method, system and computer-usable medium for providing a current availability status of a user to receive an instant messaging system (IMS) communication. In various embodiments, an IMS sender selects an IMS recipient to receive an IMS message. If the IMS recipient is logged-on, an IMS recipient availability system is implemented to process electronic calendar information to detect the next scheduled event for the selected IMS recipient. The time remaining before the scheduled event begins is determined and is used to generate a current availability status of the IMS recipient and is provided to the IMS sender prior to initiating an IMS session.

In one embodiment, the IMS sender and receiver are notified when the time remaining before the start of the event expires. In another embodiment, the current availability status of the IMS recipient comprises a second availability time period that is predetermined by the IMS recipient. In yet another embodiment, the IMS sender and receiver are notified when the second availability time period expires. In different embodiments, the current availability status comprises predetermined scheduled event information such as additional information about the scheduled event or messages generated by the IMS recipient. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a simplified block diagram of an instant messaging system (IMS) recipient availability system;

FIG. 3 is a flowchart showing the configuration of an IMS recipient availability system;

FIG. 4a-b are a flowchart showing the implementation of an IMS recipient availability system;

FIG. 5 shows a generalized user interface as implemented to configure IMS recipient availability settings; and

FIG. 6 shows a generalized user interface as implemented to determine the current availability of an IMS recipient.

### DETAILED DESCRIPTION

A method, system and computer-usable medium are disclosed for providing a current availability status of a user to receive an instant messaging communication. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit”, “module”, or “system”. Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therein, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

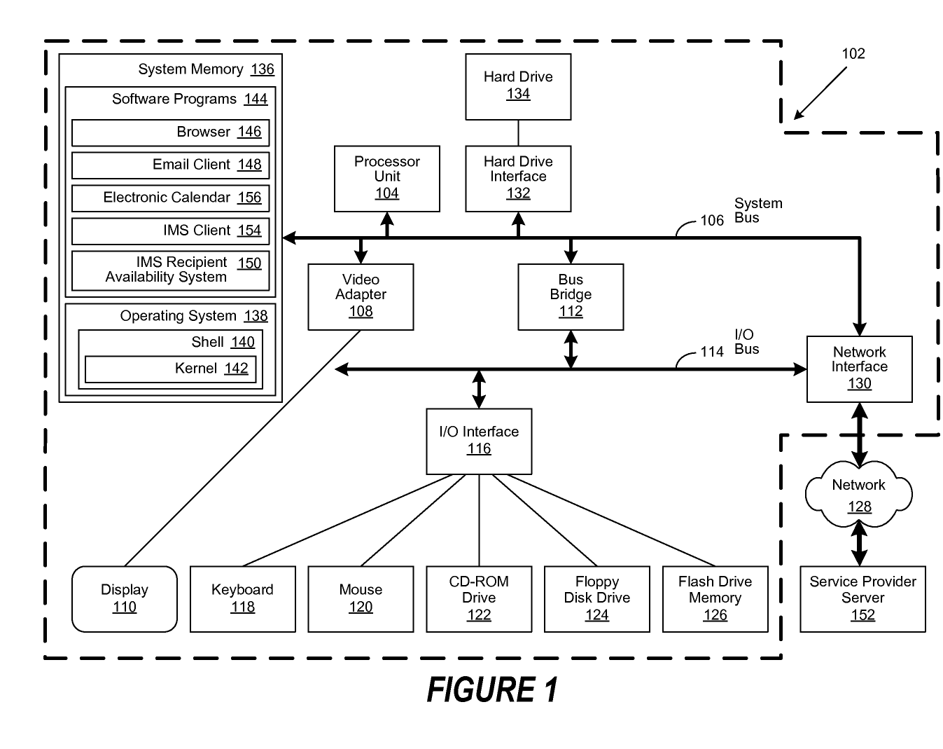

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

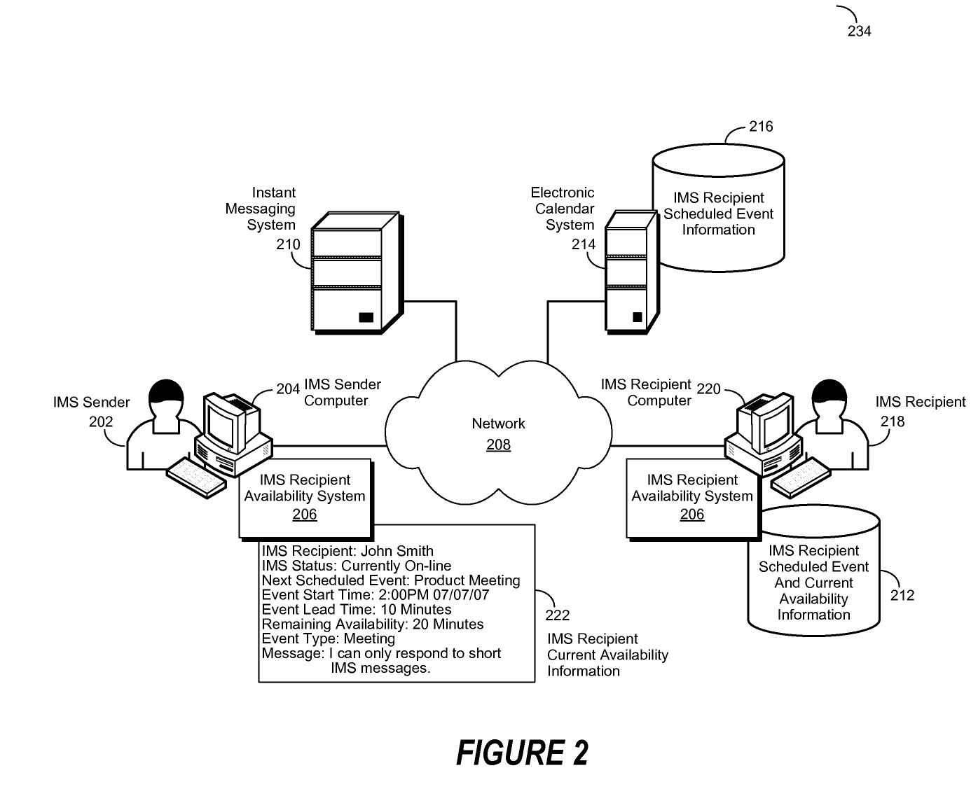

Software programs 144 may include a browser 146, email client 148, instant messaging system (IMS) client 154, and electronic calendar 156. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Software programs 144 also include an IMS recipient availability system 150. IMS recipient availability system 150 includes code for implementing the processes described in FIGS. 2 through 6 described hereinbelow. In one embodiment, client computer 102 is able to download IMS recipient availability system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a simplified block diagram of an instant messaging system (IMS) recipient availability system as implemented in accordance with an embodiment of the invention. In various embodiments, IMS recipient availability system 206 is respectively implemented on IMS sender computer 204 and IMS recipient computer 220. IMS recipient 218 processes event information 216 associated with a scheduled event stored on electronic calendar system 214. In one embodiment, scheduled event information 216 resides on an electronic calendar system 214 and is retrieved as needed by the IMS recipient availability system 206 through network 208. In another embodiment, the external electronic calendar is respectively implemented as a separate software program on the IMS sender and recipient computers 204, 220. In a different embodiment, the electronic calendar is implemented within the IMS recipient availability system 206. Skilled practitioners of the art will realize that many such embodiments are possible and that the foregoing examples are neither exhaustive nor limiting in their scope.

Regardless of its location, the scheduled event information 216 is imported into the IMS recipient availability system 206 of the IMS recipient 218. Once imported, the IMS recipient 218 selects a predetermined scheduled event and then applies lead time and grace period scheduling allowances. For example, the selected scheduled event an external lunch. The IMS recipient 218 would prefer to leave at 12:00 PM, but the actual departure time is at their discretion and IMS messages can be accepted until they leave. However, the IMS recipient 218 would also prefer to leave no later than 12:30 PM. As a result, a lead time of zero minutes is applied to the scheduled event, but a grace period of 30 minutes is applied as well. In this example, the IMS recipient could receive an incoming IMS message at 11:59 AM and the IMS session could continue until 12:30 PM before the predetermined grace period expired.

The lead time, grace period, and additional IMS recipient availability information 212 are then applied to the scheduled event. In one embodiment, a message from the IMS recipient 218 can be displayed to an IMS message sender 202 before the IMS session is initiated. For example, the IMS recipient 218 may enter text saying that an upcoming meeting is mandatory and they won't be able to accept IMS messages for the next two hours.

In different embodiments, an IMS session is initiated by IMS sender 202, who selects the IMS recipient 218 from within an IMS client application running on their IMS sender computer 204. The IMS client application then determines whether the selected IMS recipient 218 is currently logged on to the instant messaging system 210. If they are, then the IMS recipient availability system 206 running on the IMS sender computer 204 retrieves IMS recipient scheduled event and availability information 212 from the IMS recipient availability system 206 running on the IMS recipient computer 220.

The IMS recipient scheduled event and availability information 212 is then processed by the IMS recipient availability system 206 running on the IMS sender computer 204 to detect the next scheduled event of IMS recipient 218. If a scheduled event is detected, then the available time for the IMS recipient 218 to receive an IMS message is determined.

For example, the current local time for the IMS recipient 218 is 1:30 PM. The IMS recipient's next scheduled event begins at 2:00 PM and has a lead time of ten minutes. As a result, the IMS recipient has a current time availability of twenty minutes to participate in an IMS session. Once the IMS recipient's time availability has been determined, IMS recipient current availability information 222 is provided to the IMS message sender 202. In one embodiment, the IMS recipient current availability information 222 includes supplemental information, such as a message. For example, the message may state that while the IMS recipient is preparing for the upcoming meeting, they will only be available to respond to short IMS messages.

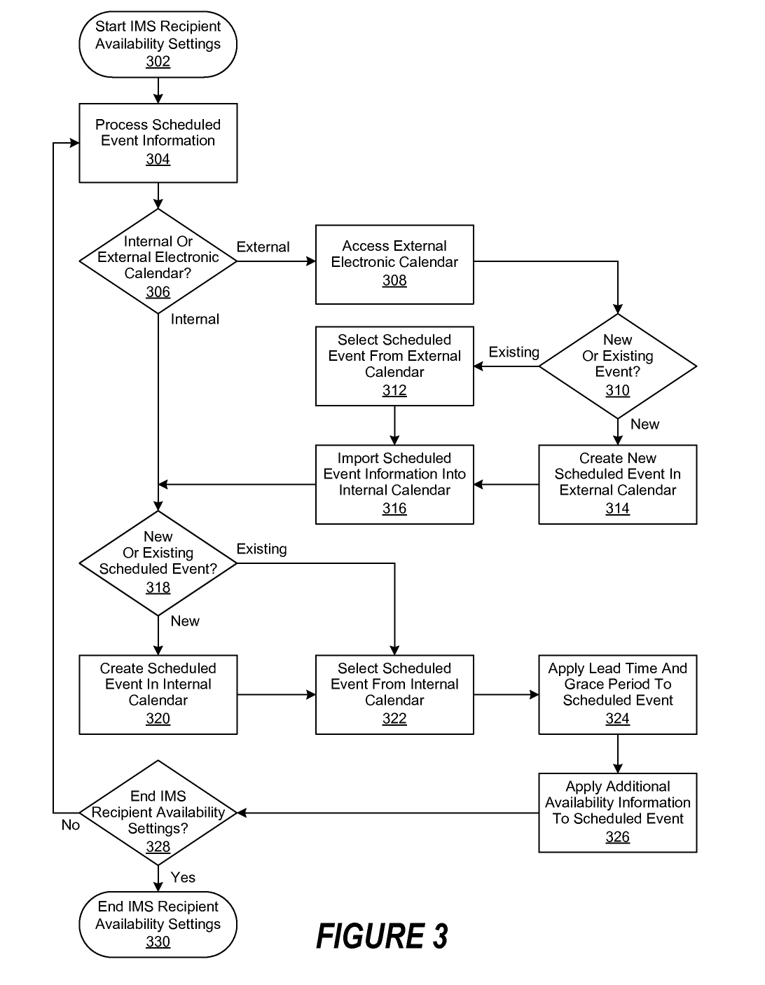

FIG. 3 is a flowchart showing the configuration of an instant messaging system (IMS) recipient availability system implemented in accordance with an embodiment of the invention. In this embodiment, the configuration of IMS recipient availability settings for a scheduled event is begun in step 302. In step 304, an IMS recipient availability system user initiates processing of event information associated with the scheduled event. In step 306, a determination is made whether the event information resides on an external electronic calendar or an electronic calendar implemented within the IMS recipient availability system. In one embodiment, the scheduled event information resides on an external electronic calendar and is retrieved as needed by the IMS recipient availability system. In another embodiment, the external electronic calendar is implemented on a server and accessed through a network connection. In yet another embodiment, the electronic calendar is implemented as a separate software program on the IMS user's machine. In a different embodiment, an electronic calendar is implemented within the IMS recipient availability system.

If it is determined in step 306 that the scheduled event information resides on an external electronic calendar, then the external electronic calendar is accessed in step 308. A determination is then made in step 310 whether the scheduled event currently exists or is a new event. If it is determined in step 310 that a new event is to be created, then the new event is created on the external electronic calendar in step 314. However, if it is determined in step 310 that the scheduled event currently exists, then it is selected in step 312. Whether the scheduled event currently exists or is newly created, its associated event information is imported into the internal calendar of the IMS recipient availability system in step 316.

However, if it is determined in step 306 that the scheduled event information resides on an internal electronic calendar, then a determination is made in step 318 whether the scheduled event currently exists or is a new event. If it is determined in step 318 that a new event is to be created, then the new event is created within the internal electronic calendar in step 320. If it is determined in step 318 that the scheduled event currently exists, or if it has been newly created in step 320, then it is selected from within the internal calendar in step 322.

The IMS recipient availability system user then applies lead time and grace period scheduling allowances to the selected scheduled event in step 324. For example, the selected scheduled event may be a mandatory department meeting. The user realizes that they cannot be late to the meeting, so a lead time of ten minutes is applied to the scheduled event. Similarly, the user realizes that they must leave no less than ten minutes before the start of the meeting, so a grace period of zero minutes is likewise applied to the scheduled event. As another example, the selected scheduled event an external lunch. The IMS recipient would prefer to leave at 12:00 PM, but the actual departure time is at their discretion and IMS messages can be accepted until they leave. However, the IMS recipient would also prefer to leave no later than 12:30 PM. As a result, a lead time of zero minutes is applied to the scheduled event, but a grace period of 30 minutes is applied as well. In this example, the IMS recipient could receive an incoming IMS message at 11:59 AM and the IMS session could continue until 12:30 PM before the predetermined grace period expired.

Once the lead time and grace period have been applied to the scheduled event, additional IMS recipient availability information is applied to the scheduled event in step 326. In one embodiment, a message from the IMS recipient can be displayed to an IMS message sender before the IMS session is initiated. For example, the IMS recipient may enter text saying that an upcoming meeting is mandatory and they won't be able to accept IMS messages for the next two hours. As another example, the IMS recipient may enter text saying that while they would like to leave for lunch by 12:00 PM and if the IMS message sender may wish to join them instead of conducting and IMS session. Conversely, the message may state that the IMS recipient is willing to postpone their lunch if the IMS message sender is unable to join them, yet has a time-critical issue to resolve. Once the additional availability information is applied to the selected scheduled event, a determination is made in step 328 whether to continue IMS recipient availability system configuration operation. If a determination is made to continue configuration operations, then the process is repeated, beginning with step 304. Otherwise, IMS recipient availability system configuration operations are ended in step 330.

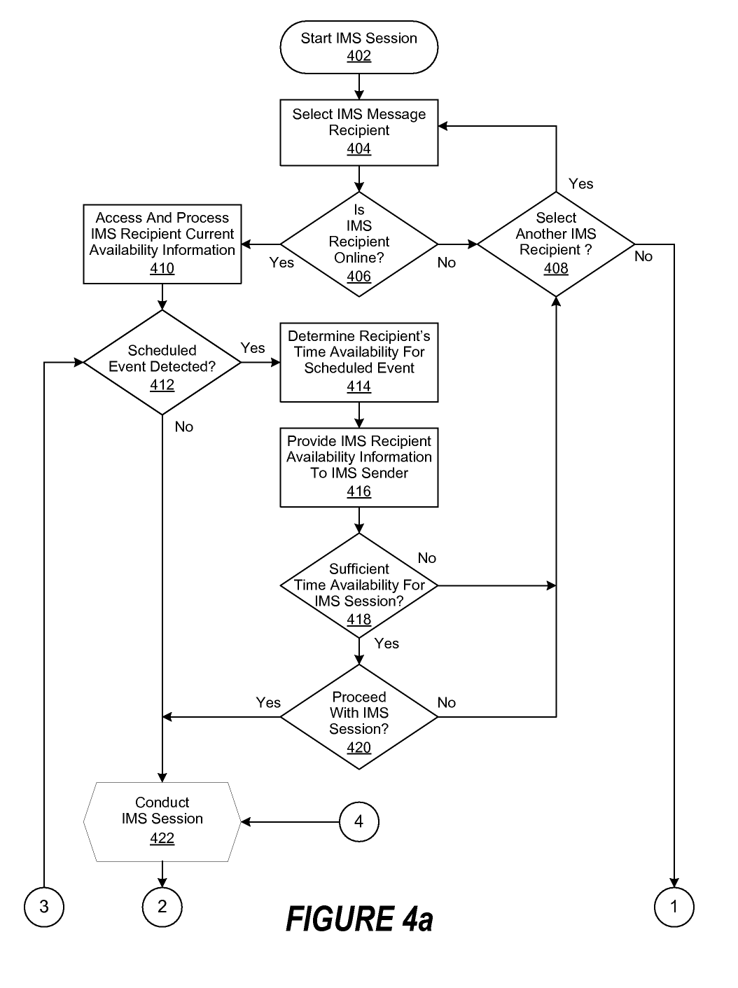

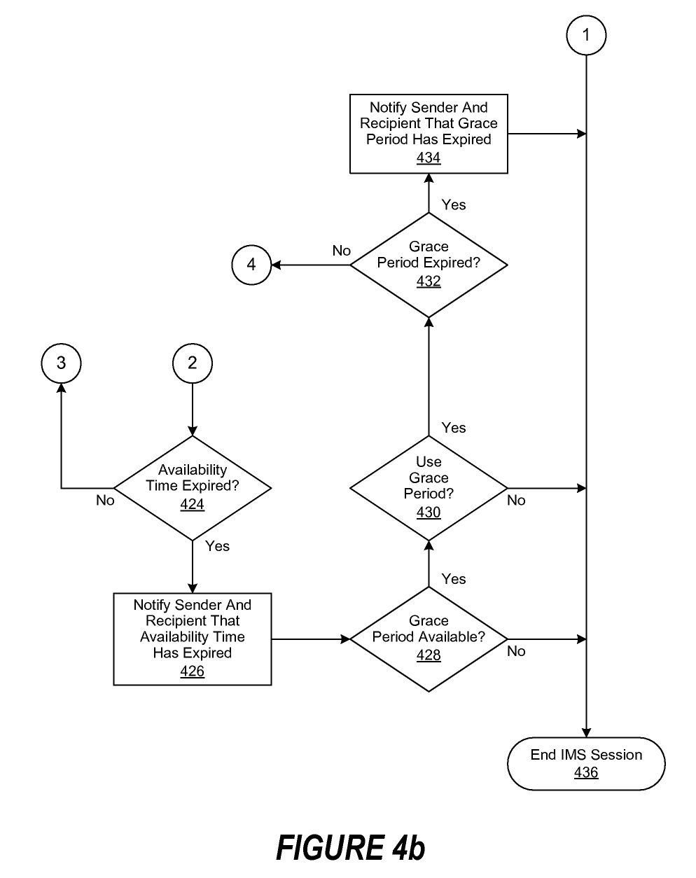

FIGS. 4a-b are a flowchart showing the implementation of an instant messaging system (IMS) recipient availability system in accordance with an embodiment of the invention. In this embodiment, an IMS session is begun in step 402. In step 404 an IMS message sender selects an IMS recipient within an IMS client application. A determination is then made in step 406 whether the selected IMS recipient is currently signified to be on-line. If it is determined in step 406 that the selected IMS recipient is not on-line, then a determination is made in step 408 whether to select another IMS recipient. If it is determined in step 408 to select another IMS recipient, then the process is repeated, beginning with step 404. Otherwise, the IMS session is ended in step 436. However, if it is determined in step 406 that the IMS recipient is currently signified to be on-line then the IMS recipient availability system accesses current availability information of the selected IMS recipient in step 410. The current availability information is then processed by the IMS recipient availability system to detect the IMS recipient's next scheduled event.

If it is determined in step 412 that a scheduled event has been detected, then the recipient's availability time to receive an IMS message is determined in step 414. For example, the current local time for the IMS recipient is 1:30 PM. The IMS recipient's next scheduled event begins at 2:00 PM and has a lead time of ten minutes. As a result, the IMS recipient has a current time availability of twenty minutes to participate in an IMS session. Once the IMS recipient's time availability has been determined, additional availability information, such as a brief message, is provided to the IMS message sender in step 416. For example, the message may state that while the IMS recipient is preparing for the upcoming meeting and is only available to respond to short IMS messages.

A determination is then made by the IMS message sender in step 418 whether the IMS message recipient has sufficient time availability for an IMS session. For example, the IMS message recipient may only have three minutes of availability before the scheduled event begins. The IMS message sender, realizing that they need to spend at least ten minutes with the IMS message recipient, decides not to proceed with the IMS session. If it is determined in step 418 that there is insufficient time availability, then the process is repeated, beginning with step 408. Otherwise, a determination is made by the IMS message sender in step 420 whether to proceed with the IMS session in step 420. If it is determined to not proceed with the IMS session, then the process is repeated, beginning with step 408. As an example, the IM message recipient may have sufficient time availability, but the IMS session is preempted by another event, such as the IMS message sender taking an incoming phone call. Otherwise, or if a scheduled event is not detected in step 412, then the IMS session is conducted between the IMS message sender and the IMS message recipient in step 422.

A determination is then made in step 424 whether the IMS message recipient's availability time has expired. If it has not, then the IMS session continues, beginning with step 422. However, if it is determined that the IMS message recipient's availability time has expired, then both the IMS message sender and the IMS message recipient are notified in step 426. A determination is then made by the IMS message recipient in step 428 whether a grace period is available. For example, the IMS recipient's scheduled event may be an external lunch. The IMS recipient would prefer to leave at 12:00 PM, but the actual departure time is at their discretion and IMS messages can be accepted until when they leave. However, the IMS recipient would also prefer to leave no later than 12:30 PM. As a result, the IMS recipient has applied a lead time of zero minutes to the scheduled event, and a grace period of 30 minutes as well. In this example, the IMS recipient could receive an incoming IMS message at 11:59 AM and the IMS session could continue until 12:30 PM before the predetermined grace period expired.

If it is determined in step 428 that a grace period is not available for use by the IMS message recipient, then the IMS session is ended in step 436. Otherwise, the IMS message recipient decides in step 430 whether or not to use the grace period. If the IMS message recipient decides not to use the grace period, then the IMS session is ended in step 436. Otherwise, a determination is made in step 432 whether the grace period has expired. If it has not, then the IMS session continues, beginning with step 422. Otherwise, both the IMS message sender and the IMS message recipient are notified in step 434 that the grace period has expired and the IMS session is ended in step 436.

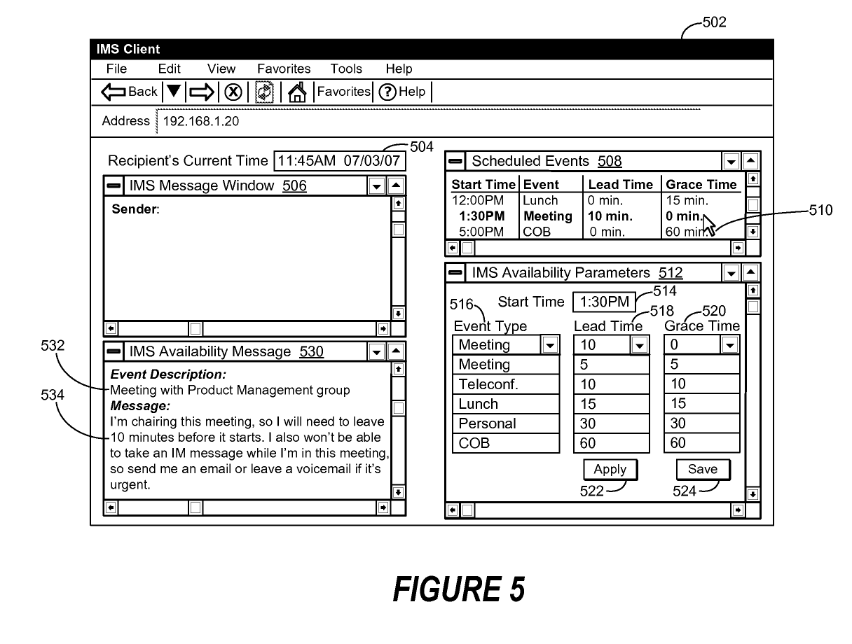

FIG. 5 shows a generalized user interface as implemented to configure instant messaging system (IMS) recipient availability settings in an embodiment of the invention. In this embodiment, IMS client user interface (UI) 502 comprises windows for the IMS recipient's current time 504, scheduled events 508, IMS recipient availability parameters 512, and IMS availability message 530. A scheduled event in the scheduled events window 508 is selected by the IMS recipient through a user gesture, such as placing cursor 510 over the selected event and performing a left-click. Event information, such as the start time 514 and event type 516, is then displayed in the IMS availability parameters window 512. Once selected, lead time 518 and grace period 520 scheduling allowances are applied 522 to the selected event. In one embodiment, additional information, such as an event description 532 and a message 534 from the IMS recipient are entered into the IMS availability message window 530. Once the fields of the availability parameter 512 window and the availability message window 530 have been populated, the IMS recipient availability information is saved 524.

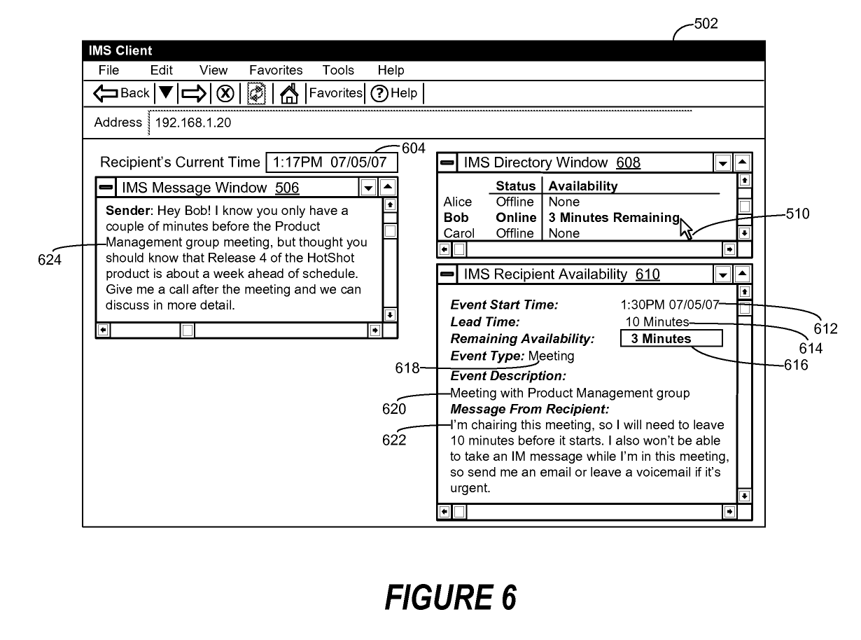

FIG. 6 shows a generalized user interface as implemented to determine the current availability of an instant messaging system (IMS) recipient in an embodiment of the invention. In this embodiment, IMS client user interface (UI) 502 comprises windows for the IMS recipient's current time 604, IMS directory window 608, and IMS recipient availability 610. An IMS recipient in the IMS directory window 608 is selected by the IMS sender through a user gesture, such as placing cursor 510 over the selected IMS recipient and performing a left-click. Current availability information for the selected IMS recipient, such as the event type 618, event description 620, and a message from the recipient 622 is displayed in the IMS recipient availability window 610. Similarly, event start time 612, lead time 614 and the remaining availability 618 of the IMS message recipient is also displayed in the IMS recipient availability window 610. Based on the IMS recipient availability information displayed in the IMS recipient availability window 610, the IMS message sender can make a determination of whether there is sufficient availability remaining to initiate an IMS session. If so, a message 624 can be composed in IMS message window 506 and the IMS session can be initiated.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for providing a current availability status of a user to receive an instant messaging system (IMS) communication, comprising:
processing calendar information of an electronic calendar to detect a scheduled event of a first user;
determining the time remaining before the scheduled event begins, the remaining time comprising a first availability time period;
generating a current availability status of the first user, the current availability status comprising the first availability time period; and
providing the current availability status of the first user to a second user prior to the second user initiating an instant messaging communication to the first user.

2. The method of claim 1, wherein the first and second user are notified when the first availability time period has expired.

3. The method of claim 1, wherein the current availability status comprises the first availability time period and a second availability time period that is defined by the first user.

4. The method of claim 3, wherein the first and second user are notified when the second availability time period has expired.

5. The method of claim 1, wherein the current availability status comprises predetermined scheduled event information.

6. The method of claim 5, wherein the predetermined scheduled event information comprises a message generated by the first user.

7. A system comprising:
a processor;
a data bus coupled to the processor; and
a computer-usable medium embodying computer program code, the computer-usable medium being coupled to the data bus, the computer program code for providing a current availability status of a user to receive an instant messaging system (IMS) communication and comprising instructions executable by the processor and configured for:
processing calendar information of an electronic calendar to detect a scheduled event of a first user;
determining the time remaining before the scheduled event begins, the remaining time comprising a first availability time period;
generating a current availability status of the first user, the current availability status comprising the first availability time period; and
providing the current availability status of the first user to a second user prior to the second user initiating an instant messaging communication to the first user

8. The system of claim 7, wherein the first and second user are notified when the first availability time period has expired.

9. The system of claim 7, wherein the current availability status comprises the first availability time period and a second availability time period that is defined by the first user.

10. The system of claim 9, wherein the first and second user are notified when the second availability time period has expired.

11. The system of claim 7, wherein the current availability status comprises predetermined scheduled event information.

12. The system of claim 11, wherein the predetermined scheduled event information comprises a message generated by the first user.

13. A computer-usable medium embodying computer program code, the computer program code comprising computer executable instructions configured for:
processing calendar information of an electronic calendar to detect a scheduled event of a first user;
determining the time remaining before the scheduled event begins, the remaining time comprising a first availability time period;
generating a current availability status of the first user, the current availability status comprising the first availability time period; and
providing the current availability status of the first user to a second user prior to the second user initiating an instant messaging communication to the first user.

14. The computer usable medium of claim 13, wherein the first and second user are notified when the first availability time period has expired.

15. The computer usable medium of claim 13, wherein the current availability status comprises the first availability time period and a second availability time period that is defined by the first user.

16. The computer usable medium of claim 15, wherein the first and second user are notified when the second availability time period has expired.

17. The computer usable medium of claim 13, wherein the current availability status comprises predetermined scheduled event information.

18. The computer usable medium of claim 17, wherein the predetermined scheduled event information comprises a message generated by the first user.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
